(19) United States
(12) Patent Application Publication
(10) Pub. No.: US 2019/0036574 A1
(43) Pub. Date: Jan. 31, 2019

(54) CSI FEEDBACK FOR OPEN LOOP FD-MIMO TRANSMISSION

(71) Applicant: Intel IP Corporation, Santa Clara, CA (US)

(72) Inventors: Yuan Zhu, Beijing (CN); Yushu Zhang, Beijing, CN (US); Wenting Chang, Beijing (CN); Alexei Davydov, Nizhny Novgorod (RU); Qinghua Li, San Ramon, CA (US)

(73) Assignee: Intel IP Corporation, Santa Clara, CA (US)

(21) Appl. No.: 16/073,298

(22) PCT Filed: Feb. 8, 2017
(86) PCT No.: PCT/US2017/016899

§ 371 Date: Jul. 26, 2018

Related U.S. Application Data
(60) Provisional application No. 62/317,206, filed on Apr. 1, 2016.

(51) Int. Cl. H04B 7/0417; H04B 7/06; H04L 5/00; H04B 7/0456

(52) U.S. Cl. CPC H04B 7/0417; H04B 7/0632; H04B 7/0639; H04L 5/0048; H04B 7/0456; H04B 7/0626

(57) ABSTRACT

Briefly, in accordance with one or more embodiments, an apparatus of a user equipment (UE) comprises one or more baseband processors to decode one or more channel state information reference signals (CSI-RS) received from an evolved Node B (eNB) using open loop full-dimension multiple input, multiple output (FD-MIMO), and to generate feedback to the eNB responsive to the one or more CSI-RS signals, and a memory to store a Class A codebook from which the feedback is generated, wherein the feedback includes an i1 codebook index of the Class A codebook and a channel quality indicator (CQI) determined based at least in part on i2 codebook index cycling across one or more physical resource blocks (PRBs). In some embodiments, Class B feedback using a Class B codebook by be utilized.

### CROSS-REFERENCE TO RELATED APPLICATIONS

The present application claims the benefit of US Provisional Application No. 62/317,206 (P97633Z) filed Apr. 1, 2016. Said Application No. 62/317,206 is hereby incorporated herein by reference in its entirety.

### BACKGROUND

Open loop multiple-input, multiple-output (MIMO) techniques have been understood to provide better performance and less feedback overhead than closed loop MIMO techniques in high Doppler scenario and/or scenarios in which reliable channel state information (CSI) feedback cannot be obtained. Transmission mode 2 (TM2) and Transmission mode 3 (TM3) based open loop MIMO techniques have been widely used in the legacy Long Term Evolution (LTE) systems. Both TM2 and TM3 are based on cell-specific reference signals (CRSs) for demodulation. As the number of antennas increases, CRS based demodulation becomes less efficient than demodulation reference signal (DMRS) based demodulation in terms of reference signal overhead. CRS itself also becomes a limitation factor for energy efficiency and flexible network resource utilization. As a result, TM2 and TM3 lack forward compatibility when network evolves towards DMRS-based demodulation, for example DMRS-based open loop full dimension MIMO (FD-MIMO).

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a diagram of a radio access network to implement CSI feedback for open loop full-dimension multiple input, multiple output (FD-MIMO) using Class A feedback in accordance with one or more embodiments;

FIG. 2 is a diagram of a radio access network to implement CSI feedback for open loop full-dimension multiple input, multiple output (FD-MIMO) using Class B feedback in accordance with one or more embodiments;

FIG. 3 is a diagram of an FD-MIMO framework in accordance with one or more embodiments;

FIG. 4 is a block diagram of an information handling system capable of implementing mobility measurements for beamforming in accordance with one or more embodiments;

FIG. 5 is an isometric view of an information handling system of FIG. 7 that optionally may include a touch screen in accordance with one or more embodiments; and

FIG. 6 is a diagram of example components of a wireless device in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. It will, however, be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. It should be noted, however, that “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

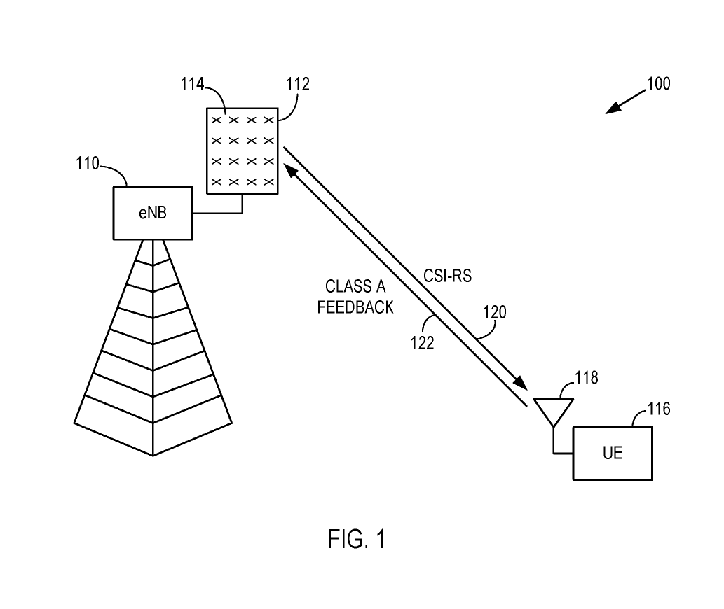

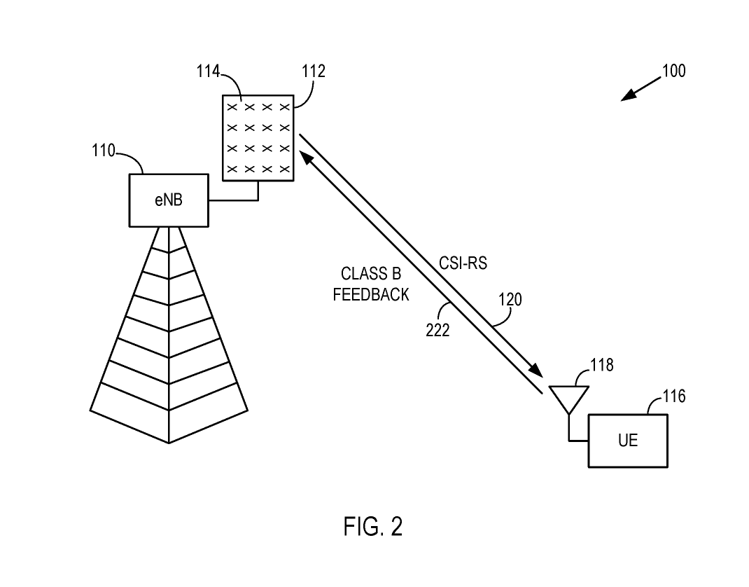

Referring now to FIG. 1, a diagram of a radio access network to implement CSI feedback for open loop full-dimension multiple input, multiple output (FD-MIMO) using Class A feedback in accordance with one or more embodiments will be discussed. As shown in FIG. 1, radio access network 100 may include an evolved Node B (eNB) 110 having an antenna 112 comprising an array of antennas 114 capable to implement full-dimension multiple input, multiple output (FD-MIMO). In such an arrangement, eNB 100 may be capable to communicate with one or more user equipment (UE) 116 devices having one or more antennas 118 using FD-MIMO techniques. In one or more embodiments, radio access network 100 may enhance the demodulation reference signal (DMRS) based open loop techniques in accordance with a Third Generation Partnership Project (3GPP) Long Term Evolution (LTE) standard. For example, in Release 13 of the LTE standard for FD-MIMO, closed loop MIMO operations have been defined for {8, 12, 16} antenna ports assuming a planar antenna array with one-dimensional (1D) and two-dimensional (2D) antenna port layouts. Class A feedback operation, as shown in FIG. 1, is defined as utilizing non-precoded channel state information reference signals (CSI-RS) for FD-MIMO operation, and Class B feedback operation, as shown in FIG. 2 below, is defined as utilizing beamformed CSI-RS for FD-MIMO operation. For class A operation, a configurable three-dimension (3D) codebook has been defined to the Release 10 transmission (Tx) dual codebook structure to 3D. For class B operation, a beam indication based approach has been defined using a channel state information reference signal resource indicator (CRI) in addition to a beam selection codebook based approach. Thus, the CSI enhancement for DMRS-based open loop MIMO additionally may support FD-MIMO operation. As shown in FIG. 1, eNB 110 may send one or more CSI-RS transmissions 120 to UE 116, and in turn UE 116 may send one or more CSI feedback transmissions to eNB 110.

In one or more embodiments, radio access network 100 may utilize an enhancement to CSI feedback for DMRS-based open loop FD-MIMO transmission. The enhancement also may be utilized for a number of antenna ports greater than 16 for FD-MIMO operation. As discussed further herein, such an enhancement to CSI feedback therefore may apply to Class A open loop FD-MIMO operation, Class B open loop FD-MIMO operation with one CSI-RS resources configured, Class B open loop FD-MIMO operation with more than one CSI-RS resource configured, and/or to two or four ports open loop MIMO rank one operation, although the scope of the claimed subject matter is not limited in these respects.

Class A Open Loop FD-MIMO Operation

For the newly defined three-dimensional (3D) codebook, one grid of beams may be extended from one dimension to two dimensions to cover both azimuth and zenith beams. As a result, the i₁ index may be split into two sub-indexes, i_{1,1} and i_{1,2}. The i₂ index still may be used to select one beam within the grid of beams indicated by i_{1,1} and i_{1,2} and also describes the co-phasing information for the beams of different polarizations.

In a first kind of Class A open loop FD-MIMO operation, UE 116 still will feedback the first precoder index i₁. Conceptually, the grid of beam is still relying on the CSI feedback transmission 122 from UE 116 using Class A feedback wherein a codebook index is fed back to the transmitter, but the intra-grid beam selector and co-phasing is randomly cycled across physical resource blocks (PRBs.) Such an arrangement may be beneficial when eNB 110 is only confident with the coarse beam selection based on i₁, that is i_{1,1} and i_{1,2,} but not confident with the finer beam and co-phasing feedback i₂. This can be due to Doppler and higher reliability of the coarser beam selection.

For all the embodiments about precoder cycling discussed below, the cycling granularity may be per PRB or per multi-PRBs, such as one PRB bundle. The number of precoders to cycle for each PRB and/or multi-PRBs can be either 2 or 4 for rank one. The number of precoders to cycle for each PRB and/or multi-PRBs may be fixed to one for rank greater than one. Several embodiments may be described as follows.

In one or more embodiments, UE 116 provides feedback to eNB 110 for i₁ index of Class A codebook and assumes i₂ cycling across PRBs when deriving channel quality information (CQI) to eNB 110 as part of CSI feedback transmission 122. In another embodiment, UE 116 provides feedback to eNB 110 on i₁ index and assumes i₂ cycling across PRBs when deriving CQI for Codebook-Config=1. In a further embodiment, UE 116 provides feedback to eNB 110 for i₁ index and assumes i₂ cycling among a subset, for example using i₂ codebook index {0, 1} for rank two, among all PRBs when deriving CQI for Codebook-Config=1. In a further embodiment, UE 116 provides feedback for it index and assumes i₂ cycling among a subset, for example always using two codebook index {0, 1} for rank one for all PRBs assuming physical downlink shared channel (PDSCH) resource elements (REs) in each PRB associated with these two codebook indexes alternatively when deriving CQI for Codebook-Config=1.

In another embodiment, UE 116 provides feedback for i₁ index and assumes i₂ cycling among a subset with different beams among all PRBs when deriving CQI for rank one for Codebook-Config=2, Codebook-Config=3, or Codebook-Config=4, for example only using codebook indexes {0, 4, 8, 12}. Each PRB only may be associated with one codebook index or two codebook indexes. In an additional embodiment, UE 116 provides feedback for i₁ index and assumes i₂ cycling among a subset when deriving rank two CQI for Codebook-Config=2/3/4. The subset only contains codewords with the same beam and different co-phasing for both layers, e.g. {0, 2, 4, 6}. In a further embodiment, UE 116 provides feedback for i₁ index and assumes i₂ cycling among a subset when deriving rank 3/4/5/6/7/8 CQI for Codebook-Config=2, Codebook-Config=3, or Codebook-Config=4. The subset may only contain single codeword, for example {0}.

In the second kind of Class A open loop FD-MIMO operation, UE 116 provides feedback for i_{1,1} or i_{1,2} but not both. Precoder cycling may be based on the other i₁ sub-index and i₂. In this embodiment, it is assumed that UE 116 usually moves on the ground, and i_{1,2} may change much slower than i_{1,1}. In a further embodiment, UE 116 provides feedback for i_{1,1} and assumes i_{1,2} and i₂ cycling for each PRB when deriving CQI. In an additional embodiment, UE 116 provides feedback i_{1,2} and assumes i_{1,1} and i₂ cycling for each PRB when deriving CQI. In yet another embodiment, UE 116 provides feedback on i_{1,2} index and assumes i_{1,1} cycling among a subset, for example {0, O₁N₁/D₁, 2O₁N₁/D₁, . . . , (D₁-1)O₁N₁/D₁}, and that i₂ is selected from one subset, for example only using codebook index 0 for rank 1/2/5/6/7/8, among all PRBs when deriving CQI for Codebook-Config=1. For rank 1, each PRB may be associated with one i_{1,1} index or two i_{1,1} indexes. Parameter D1 may be described, for example defined in the specification, equal to O₁, or higher layer configured.

In a further embodiment, UE 116 provides feedback on i_{1,2} index and assumes i_{1,1} cycling among a subset, for example {0, O₁N₁/D₁, 2O₁N₁/D₁, . . . , (D₁-1)2O₁N₁/D₁}, and that i₂ is selected from one subset, for example only using codebook index 0 for rank 3 or rank 4, among all PRBs when deriving CQI for Codebook-Config=1. In another embodiment, UE 116 provides feedback on i_{1,2} index and assumes i_{1,1} cycling among a subset, for example {0, S₁(v)/D₁, 2 S₁(v)/D₁, . . . , (D₁-1) S₁(v)/D₁}, and that i₂ is selected from one subset, for example from codebook index {0, 2, 4, 6} for rank 1/2, among all PRBs when deriving CQI for Codebook-Config=2/3/4. S₁(v) is the rank dependent bit width of N₁ dimension. For rank 1, each PRB can be associated with one or two cycled or rotated precoders.

In the third kind of Class A open loop FD-MIMO operation, UE 116 does not feedback i₁ and i₂ indexes. In another embodiment, UE 116 does not feedback i₁, i₂, and UE 116 may assume i₁ and i₂ cycling for each PRB when deriving CQI.

Class B Open Loop FD-MIMO Operation with One CSI-RS Resource Configured

Referring now to FIG. 2, a diagram of a radio access network to implement CSI feedback for open loop full-dimension multiple input, multiple output (FD-MIMO) using Class B feedback in accordance with one or more embodiments will be discussed. The configuration and operation of radio access network 100 of FIG. 2 is substantially similar to that of FIG. 1, except that CSI feedback transmission 222 is configured for Class B feedback wherein a beam index is fed back to the transmitter as compared to Class A feedback where a codebook index is fed back to the transmitter. In one or more embodiments, UE 116 does not feedback precoding matrix indicator (PMI) information, and UE 116 assumes available codebook index for each rank may be cycled alternatively for each physical resource block (PRB) when deriving channel quality information (CQI). One PRB may be associated with either one precoder or two different precoders. In another embodiment, if UE 116 is configured with CSI-RS {15, 16}, UE 116 assumes one precoder in the 2 ports codebook for all PRBs. The rank one precoder can be any of the available rank one precoder or any two of the available rank one precoders. The rank two precoder can be any of the available rank two precoder. For example, the first codebook index for rank one and two may be assumed. In an additional embodiment, if UE 116 may be configured with CSI-RS {15, 16, 17, 18}, for rank one, UE 116 may assume only two codebook indexes are used for cycling among PRBs according to Table 7.2.4-19 of 3GPP Technical Standard (TS) 36.213 v13.0.1, reproduced below.

TABLE 7.2.4-19
Codebook for υ-layer CSI reporting using antenna ports

| Codebook | Number of layers υ | | | |
|---|---|---|---|---|
| index, n | 1 | 2 | 3 | 4 |
| 0 | $\frac{1}{\sqrt{2}} [ \begin{matrix}{e}_{0}^{( 2 )} \\ {e}_{0}^{( 2 )}\end{matrix} ]$ | $\frac{1}{2} [ \begin{matrix}{e}_{0}^{( 2 )} & {e}_{0}^{( 2 )} \\ {e}_{0}^{( 2 )} & - {e}_{0}^{( 2 )}\end{matrix} ]$ | $\frac{1}{\sqrt{6}} [ \begin{matrix}{e}_{0}^{( 2 )} & {e}_{0}^{( 2 )} & {e}_{1}^{( 2 )} \\ {e}_{0}^{( 2 )} & - {e}_{0}^{( 2 )} & - {e}_{1}^{( 2 )}\end{matrix} ]$ | $\frac{1}{2 \sqrt{2}} [ \begin{matrix}{e}_{0}^{( 2 )} & {e}_{1}^{( 2 )} & {e}_{0}^{( 2 )} & {e}_{1}^{( 2 )} \\ {e}_{0}^{( 2 )} & {e}_{1}^{( 2 )} & - {e}_{0}^{( 2 )} & - {e}_{1}^{( 2 )}\end{matrix} ]$ |
| 1 | $\frac{1}{\sqrt{2}} [ \begin{matrix}{e}_{0}^{( 2 )} \\ - {e}_{0}^{( 2 )}\end{matrix} ]$ | $\frac{1}{2} [ \begin{matrix}{e}_{0}^{( 2 )} & {e}_{0}^{( 2 )} \\ {je}_{0}^{( 2 )} & - {je}_{0}^{( 2 )}\end{matrix} ]$ | $\frac{1}{\sqrt{6}} [ \begin{matrix}{e}_{1}^{( 2 )} & {e}_{0}^{( 2 )} & {e}_{1}^{( 2 )} \\ {e}_{1}^{( 2 )} & - {e}_{0}^{( 2 )} & - {e}_{1}^{( 2 )}\end{matrix} ]$ | $\frac{1}{2 \sqrt{2}} [ \begin{matrix}{e}_{0}^{( 2 )} & {e}_{1}^{( 2 )} & {e}_{0}^{( 2 )} & {e}_{1}^{( 2 )} \\ {je}_{0}^{( 2 )} & {je}_{1}^{( 2 )} & - {je}_{0}^{( 2 )} & - {je}_{1}^{( 2 )}\end{matrix} ]$ |
| 2 | $\frac{1}{\sqrt{2}} [ \begin{matrix}{e}_{0}^{( 2 )} \\ j \cdot {e}_{0}^{( 2 )}\end{matrix} ]$ | $\frac{1}{2} [ \begin{matrix}{e}_{1}^{( 2 )} & {e}_{1}^{( 2 )} \\ {e}_{1}^{( 2 )} & - {e}_{1}^{( 2 )}\end{matrix} ]$ | $\frac{1}{\sqrt{6}} [ \begin{matrix}{e}_{0}^{( 2 )} & {e}_{1}^{( 2 )} & {e}_{1}^{( 2 )} \\ {e}_{0}^{( 2 )} & {e}_{1}^{( 2 )} & - {e}_{1}^{( 2 )}\end{matrix} ]$ | — |
| 3 | $\frac{1}{\sqrt{2}} [ \begin{matrix}{e}_{0}^{( 2 )} \\ - j \cdot {e}_{0}^{( 2 )}\end{matrix} ]$ | $\frac{1}{2} [ \begin{matrix}{e}_{1}^{( 2 )} & {e}_{1}^{( 2 )} \\ {je}_{1}^{( 2 )} & - {je}_{1}^{( 2 )}\end{matrix} ]$ | $\frac{1}{\sqrt{6}} [ \begin{matrix}{e}_{1}^{( 2 )} & {e}_{0}^{( 2 )} & {e}_{0}^{( 2 )} \\ {e}_{1}^{( 2 )} & {e}_{0}^{( 2 )} & - {e}_{0}^{( 2 )}\end{matrix} ]$ | — |
| 4 | $\frac{1}{\sqrt{2}} [ \begin{matrix}{e}_{1}^{( 2 )} \\ {e}_{1}^{( 2 )}\end{matrix} ]$ | $\frac{1}{2} [ \begin{matrix}{e}_{0}^{( 2 )} & {e}_{1}^{( 2 )} \\ {e}_{0}^{( 2 )} & - {e}_{1}^{( 2 )}\end{matrix} ]$ | — | — |
| 5 | $\frac{1}{\sqrt{2}} [ \begin{matrix}{e}_{1}^{( 2 )} \\ - {e}_{1}^{( 2 )}\end{matrix} ]$ | $\frac{1}{2} [ \begin{matrix}{e}_{0}^{( 2 )} & {e}_{1}^{( 2 )} \\ {je}_{0}^{( 2 )} & - {je}_{1}^{( 2 )}\end{matrix} ]$ | — | — |
| 6 | $\frac{1}{\sqrt{2}} [ \begin{matrix}{e}_{1}^{( 2 )} \\ j \cdot {e}_{1}^{( 2 )}\end{matrix} ]$ | $\frac{1}{2} [ \begin{matrix}{e}_{1}^{( 2 )} & {e}_{0}^{( 2 )} \\ {e}_{1}^{( 2 )} & - {e}_{0}^{( 2 )}\end{matrix} ]$ | — | — |
| 7 | $\frac{1}{\sqrt{2}} [ \begin{matrix}{e}_{1}^{( 2 )} \\ - j \cdot {e}_{1}^{( 2 )}\end{matrix} ]$ | $\frac{1}{2} [ \begin{matrix}{e}_{1}^{( 2 )} & {e}_{0}^{( 2 )} \\ {je}_{1}^{( 2 )} & - {je}_{0}^{( 2 )}\end{matrix} ]$ | — | — |

The first codebook index may be from {0, 1, 2, 3} and the second codebook index may be from {4, 5, 6, 7}. For example, UE 116 may assume only codebook index 0 and index 4 are used on all PRBs alternatively. Alternatively, UE 116 may assume two codebook indexes are used for all PRBs with each PRB associated with two precoders.

In a further embodiment, if UE 116 is configured with CSI-RS {15, 16, 17, 18}, for rank two, UE 116 can assume only two codebook indexes are used for cycling among PRBs according to Table 7.2.4-19 of 3GPP TS 36.213 v13.0.1. The first codebook index is from {0, 1} and the second codebook index is from {2, 3}. For example, UE 116 may assume only codebook index 0 and 2 are used on all PRBs alternatively. In an additional embodiment, if UE 116 is configured with CSI-RS {15, 16, 17, 18}, for rank two, UE 116 may assume only two codebook indexes are used for rotating among PRBs according to Table 7.2.4-19 of TS 36.213 v13.0.1. The first codebook index is from {4, 5} and the second codebook index is from {6, 7}. For example, UE 116 may assume only codebook index 4 and 6 are used on all PRBs alternatively.

In another embodiment, if UE 116 is configured with CSI-RS {15, 16, 17, 18}, for rank two, UE 116 may assume only one codebook index is used for all PRBs according to table 7.2.4-19 of TS 36.213 v13.0.1. The codebook index is from {4, 5, 6, 7}. For example, UE 116 may assume only codebook index 4 is used on all PRBs.

In yet another embodiment, if UE 116 is configured with CSI-RS {15, 16, 17, 18}, for rank three/four, UE can assume only one codebook index is used for all PRBs according to table 7.2.4-19 of TS 36.213 v13.0.1. For example, UE 116 may assume only codebook index 0 is used on all PRBs.

In an additional embodiment, if UE 116 is configured with CSI-RS {15, 16, 17, 18, 19, 20, 21, 22}, for rank one, UE 116 may assume only four codebook indexes are used for rotating among PRBs according to 7.2.4-19 of TS 36.213 v13.0.1. The kth codebook index is from {4k, 4k+1, 4k+2, 4k+3}. For example, UE 116 may assume codebook indexes {0, 4, 8, 12} are used on all PRBs alternatively. Each PRB also may be associated with two different precoder indexes and the four precoders are rotated two by two per PRB.

In yet an additional embodiment, if UE 116 is configured with CSI-RS {15, 16, 17, 18, 19, 20, 21, 22}, for rank two, UE 116 may assume only four codebook indexes are used for cycling among PRBs according to table 7.2.4-19 of TS 36.213 v13.0.1. The kth codebook index is from {2k, 2k+1}. For example, UE 116 may assume codebook index {0, 2, 4, 8} are used on all PRBs alternatively.

In a further embodiment, if UE 116 is configured with CSI-RS {15, 16, 17, 18, 19, 20, 21, 22}, for rank two, UE 116 may assume only two codebook indexes are used for cycling among PRBs according to table 7.2.4-19 of TS 36.213 v13.0.1. The two codebook indexes are from codebook index {8, 9, 10, 11, 12, 13, 14, 15}. Additionally, four beam directions are covered. For example, UE 116 may assume codebook index {10, 13} are used on all PRBs alternatively.

In yet a further embodiment, if UE 116 is configured with CSI-RS {15, 16, 17, 18, 19, 20, 21, 22}, for rank three, UE 116 may assume only two codebook indexes are used for cycling among PRBs according to table 7.2.4-19 of TS 36.213 v13.0.1. Additionally, four beam directions are covered. For example, UE 116 can assume codebook indexes {0, 8} are used on all PRBs alternatively.

In another embodiment, if UE 116 is configured with CSI-RS {15, 16, 17, 18, 19, 20, 21, 22}, for rank four, UE 116 may assume only two codebook indexes are used for cycling among PRBs according to table 7.2.4-19 of TS 36.213 v13.0.1. Additionally, four beam directions are covered. For example, UE 116 may assume codebook indexes {0, 4} are used on all PRBs alternatively.

In yet another embodiment, if UE 116 is configured with CSI-RS {15, 16, 17, 18, 19, 20, 21, 22}, for rank 5/6/7/8, UE 116 may assume only one codebook index is used for all PRBs according to table 7.2.4-19 of TS 36.213 v13.0.1. Additionally, four beam directions are covered.

Class B Open Loop FD-MIMO Operation with K>1 CSI-RS Resources Configured

In one or more embodiments, if a number of channel state information reference signals (CSI-RS) ports for each CSI-RS resource is 1 or 2, wherein K is a number of CSI-RS resources, UE 116 may assume CSI-RS resource indicator (CRI) cycling among all physical resource blocks (PRBs) and fixed precoding matrix indicator (PMI) index is used when deriving channel quality indicator/rank indicator (CQI/RI). For rank 1, two PMI values may be cycled per PRB for each cycled CRI.

In another embodiment, if a number of CSI-RS ports for each CSI-RS resource is 4, UE 116 may assume CRI and PMI cycling among all PRBs when deriving CQI/RI. CRI may cycle every four PRBs. PMI may cycle every PRB, and the precoder corresponding to precoder indexes 12, 13, 14, 15 in Table 6.3.4.2.3-2 of TS 36.211 may be used, reproduced below.

| Code- | | | | | |
|---|---|---|---|---|---|
| book | | Number of layers ν | | | |
| index | uₙ | 1 | 2 | 3 | 4 |
| 0 | u₀ = [1 − 1 − 1 − 1]^{T} | W₀^{{1}} | W₀^{{14}}/\sqrt{2} | W₀^{{124}}/\sqrt{3} | W₀^{{1234}}/2 |
| 1 | u₁ = [1 − j 1 j]^{T} | W₁^{{1}} | W₁^{{12}}/\sqrt{2} | W₁^{{123}}/\sqrt{3} | W₁^{{1234}}/2 |
| 2 | u₂ = [1 1 − 1 1]^{T} | W₂^{{1}} | W₂^{{12}}/\sqrt{2} | W₂^{{123}}/\sqrt{3} | W₂^{{3214}}/2 |
| 3 | u₃ = [1 j 1 − j]^{T} | W₃^{{1}} | W₃^{{12}}/\sqrt{2} | W₃^{{123}}/\sqrt{3} | W₃^{{3214}}/2 |
| 4 | u₄ = [1 (−1 − j)/\sqrt{2} − j (1 − j)/\sqrt{2}]^{T} | W₄^{{1}} | W₄^{{14}}/\sqrt{2} | W₄^{{124}}/\sqrt{3} | W₄^{{1234}}/2 |
| 5 | u₅ = [1 (1 − j)/\sqrt{2} j (−1 − j)/\sqrt{2}]^{T} | W₅^{{1}} | W₅^{{14}}/\sqrt{2} | W₅^{{124}}/\sqrt{3} | W₅^{{1234}}/2 |
| 6 | u₆ = [1 (1 + j)/\sqrt{2} − j (−1 + j)/\sqrt{2}]^{T} | W₆^{{1}} | W₆^{{13}}/\sqrt{2} | W₆^{{134}}/\sqrt{3} | W₆^{{1324}}/2 |
| 7 | u₇ = [−1 + j)/\sqrt{2} j (1 + j)/\sqrt{2}]^{T} | W₇^{{1}} | W₇^{{13}}/\sqrt{2} | W₇^{{134}}/\sqrt{3} | W₇^{{1324}}/2 |
| 8 | u₈ = [1 − 1 1 1]^{T} | W₈^{{1}} | W₈^{{12}}/\sqrt{2} | W₈^{{124}}/\sqrt{3} | W₈^{{1234}}/2 |
| 9 | u₉ = [1 − j − 1 − j]^{T} | W₉^{{1}} | W₉^{{14}}/\sqrt{2} | W₉^{{134}}/\sqrt{3} | W₉^{{1234}}/2 |
| 10 | u₁₀ = [1 1 1 − 1]^{T} | W₁₀^{{1}} | W₁₀^{{13}}/\sqrt{2} | W₁₀^{{123}}/\sqrt{3} | W₁₀^{{1324}}/2 |
| 11 | u₁₁ = [1 j − 1 j]^{T} | W₁₁^{{1}} | W₁₁^{{13}}/\sqrt{2} | W₁₁^{{134}}/\sqrt{3} | W₁₁^{{1324}}/2 |
| 12 | u₁₂ = [1 − 1 − 1 1]^{T} | W₁₂^{{1}} | W₁₂^{{12}}/\sqrt{2} | W₁₂^{{123}}/\sqrt{3} | W₁₂^{{1234}}/2 |
| 13 | u₁₃ = [1 − 1 1 − 1]^{T} | W₁₃^{{1}} | W₁₃^{{13}}/\sqrt{2} | W₁₃^{{123}}/\sqrt{3} | W₁₃^{{1324}}/2 |
| 14 | u₁₄ = [1 1 − 1 − 1]^{T} | W₁₄^{{1}} | W₁₄^{{13}}/\sqrt{2} | W₁₄^{{123}}/\sqrt{3} | W₁₄^{{3214}}/2 |
| 15 | u₁₅ = [1 1 1 1]^{T} | W₁₅^{{1}} | W₁₅^{{12}}/\sqrt{2} | W₁₅^{{123}}/\sqrt{3} | W₁₅^{{1234}}/2 |

For rank 1, two CRI values may be used per PRB for the same PMI, or two PMI values may be used per PRB for the same CRI.

2/4 Ports CSI Feedback Enhancement for Rank One

In accordance with one or more embodiments, for 2 ports or 4 ports demodulation reference signal (DMRS) based open loop transmission, wherein rank one is based on precoder cycling instead of space frequency block coding (SFBC), the precoder cycling pattern also may be defined.

In one embodiment, if UE 116 is configured with CSI-RS {15, 16}, for rank one, UE 116 may assume all four codebook indexes are used for cycling among physical resource blocks (PRBs) with one precoder per PRB when deriving channel quality indicator (CQI). Alternatively, UE 116 may assume all four codebook indexes are used for cycling among PRBs with two precoders per PRBs, and resource elements (REs) of one PRB are associated with either of two precoders alternatively.

In an embodiment, if UE 116 may be configured with CSI-RS {15, 16, 17, 18}, for rank one, UE 116 may assume the first eight codebook indexes are used for cycling among PRBs with one precoder per PRB when deriving CQI. Alternatively, UE 116 may assume all codebook indexes are used for rotating among PRBs with two precoders per PRBs and REs of one PRB are associated with either of two precoders alternatively. Due to the large amount of precoders, the number of candidate precoders may be greater than number of PRBs in the full system bandwidth for one open loop FD-MIMO transmission.

In another embodiment, different precoder subsets may be applied to different CSI reporting subframes for open loop FD-MIMO transmission. In yet an embodiment, different precoder subsets to cycle may be dependent on system bandwidth. For example, a coarse precoder subset maybe used for a small system bandwidth and a fine precoder subset maybe used for a wide system bandwidth. In yet another embodiment, the precoders subset to cycle through PRBs may be configured by high layer signaling like codebook subsets. In an additional embodiment, which precoder subsets to choose for different CSI reporting subframes may be determined by a random seed which may be a function of both transmission point (TP) or cell identity (cell ID) or virtual cell ID and subframe index. Additionally, in any of the embodiments above, the PRB may also corresponds to the group of PRBs. For example, the group of PRBs may corresponds to Precoding Resource Group (PRG) or a set of PRGs, although the scope of the claimed subject matter is not limited in this respect.

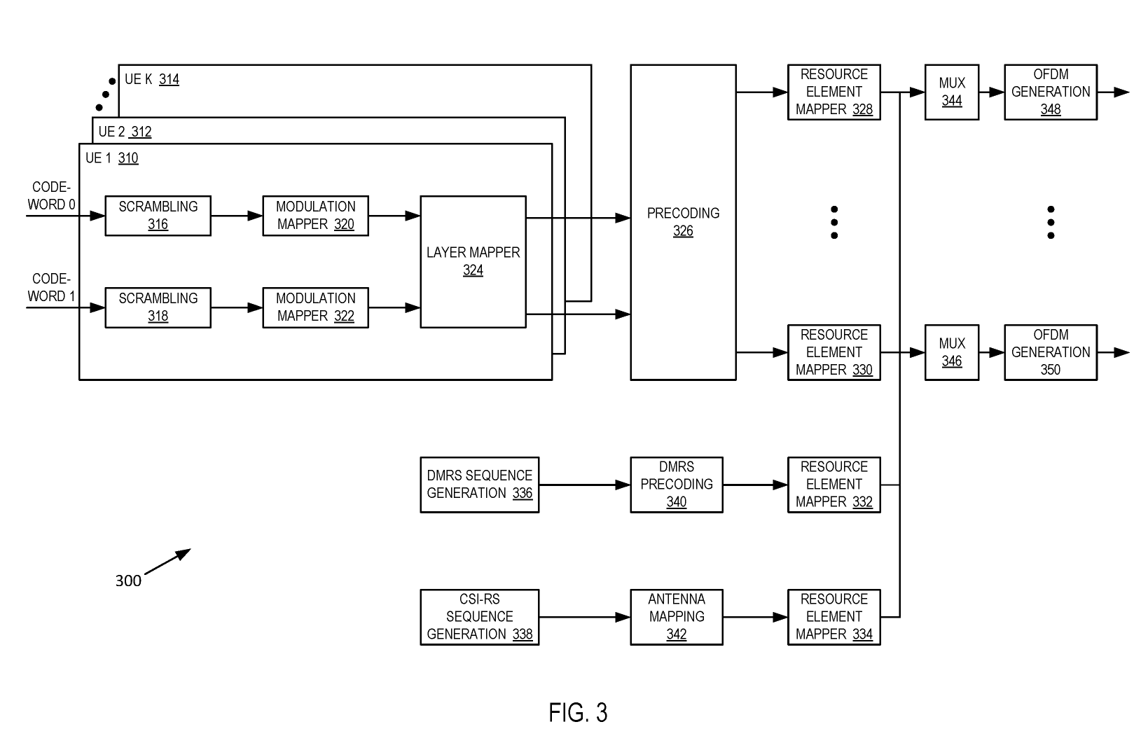

Referring now to FIG. 3, a diagram of an FD-MIMO framework in accordance with one or more embodiments will be discussed. In one or more embodiments, the FD-MIMO framework 300 of FIG. 3 may be implemented by eNB 110 of FIG. 1 or FIG. 2 to transmit CSI-RS signals as described herein to one or more UE 116 devices, and the scope of the claimed subject matter is not limited in this respect. Codeword 0 and codeword 1 may be provided for precoding for one or more UE 116 devices, for example a first UE 310 (UE 1), a second UE 312 (UE 2), up to a Kth UE (UE 314). The codewords may be provided to a respective scrambling block 316 and scrambling block 318, modulation mapper block 320 and modulation mapper block 322, and combined at layer mapper block 324. The outputs of layer mapper block 324 may be provided to precoding block 326, which in turn provides outputs to a respective one or more of resource element mapper blocks such as resource element mapper block 328 and resource mapper blocks 330. A DMRS sequence generation block 336 provides an output to DMRS precoding block 340, which in turn provides an output to resource element mapper block 332. A CSI-RS sequence generation block 338 provides an output to antenna mapping block 342, which in turn provides an output to resource element mapper block 334. The outputs of the resource element mapper blocks are combined via one or more multiplexers, for example MUX 344 and MUX 346, which in turn provides outputs to one or more orthogonal frequency division multiplexing (OFDM) blocks, for example OFDM generation block 348 and OFDM generation block 350. The outputs of the one or more OFDM generation blocks provides the CSI-RS signals to be transmitted to the one or more UE 116 devices via the array of antennas 114 of antenna 112.

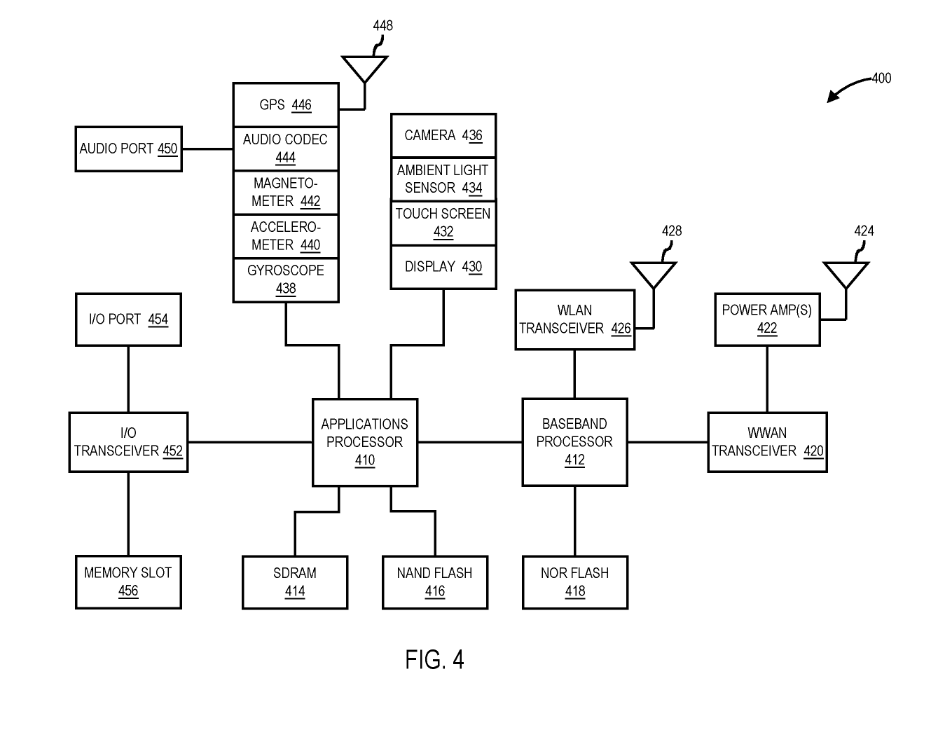

Referring now to FIG. 4, a block diagram of an information handling system capable of implementing mobility measurements for beamforming in accordance with one or more embodiments will be discussed. Although information handling system 400 represents one example of several types of computing platforms, information handling system 400 may include more or fewer elements and/or different arrangements of elements than shown in FIG. 4, and the scope of the claimed subject matter is not limited in these respects. In one or more embodiments, information handling system may tangibly embody an apparatus of a user equipment (UE), comprising one or more baseband processors to decode one or more channel state information reference signals (CSI-RS) received from an evolved Node B (eNB) using open loop full-dimension multiple input, multiple output (FD-MIMO), and to generate feedback to the eNB responsive to the one or more CSI-RS signals, and a memory to store a Class A codebook from which the feedback is generated, wherein the feedback includes an i1 codebook index of the Class A codebook and a channel quality indicator (CQI) determined based at least in part on i2 codebook index cycling across one or more physical resource blocks (PRBs). In one or more other embodiments, information handling system may tangibly embody an apparatus of a user equipment (UE), comprising one or more baseband processors to decode one or more channel state information reference signals (CSI-RS) received from an evolved Node B (eNB) using open loop full-dimension multiple input, multiple output (FD-MIMO), and to generate feedback to the eNB responsive to the one or more CSI-RS signals, and a memory to store a Class B codebook from which the feedback is generated, wherein an available codebook index for one or more ranks is cycled alternatively for each of one or more physical resource blocks wherein a physical resource block (PRB) is associated with either one precoder or two different precoders.

In one or more embodiments, information handling system 400 may include one or more applications processors 410 and one or more baseband processors 412. Applications processor 410 may be utilized as a general-purpose processor to run applications and the various subsystems for information handling system 400. Applications processor 410 may include a single core or alternatively may include multiple processing cores. One or more of the cores may comprise a digital signal processor or digital signal processing (DSP) core. Furthermore, applications processor 410 may include a graphics processor or coprocessor disposed on the same chip, or alternatively a graphics processor coupled to applications processor 410 may comprise a separate, discrete graphics chip. Applications processor 410 may include on board memory such as cache memory, and further may be coupled to external memory devices such as synchronous dynamic random access memory (SDRAM) 414 for storing and/or executing applications during operation, and NAND flash 416 for storing applications and/or data even when information handling system 400 is powered off. In one or more embodiments, instructions to operate or configure the information handling system 400 and/or any of its components or subsystems to operate in a manner as described herein may be stored on an article of manufacture comprising a non-transitory storage medium. In one or more embodiments, the storage medium may comprise any of the memory devices shown in and described herein, although the scope of the claimed subject matter is not limited in this respect. Baseband processor 412 may control the broadband radio functions for information handling system 400. Baseband processor 412 may store code for controlling such broadband radio functions in a NOR flash 418. Baseband processor 412 controls a wireless wide area network (WWAN) transceiver 420 which is used for modulating and/or demodulating broadband network signals, for example for communicating via a 3GPP LTE or LTE-Advanced network or the like.

In general, WWAN transceiver 420 may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10) , 3GPP Rel. 11 (3rd Generation Partnership Project Release 11), 3GPP Rel. 12 (3rd Generation Partnership Project Release 12), 3GPP Rel. 13 (3rd Generation Partnership Project Release 12), 3GPP Rel. 14 (3rd Generation Partnership Project Release 12), 3GPP LTE Extra, LTE Licensed-Assisted Access (LAA), UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, millimeter wave (mmWave) standards in general for wireless systems operating at 10-90 GHz and above such as WiGig, IEEE 802.11ad, IEEE 802.11ay, and so on, and/or general telemetry transceivers, and in general any type of RF circuit or RFI sensitive circuit. It should be noted that such standards may evolve over time, and/or new standards may be promulgated, and the scope of the claimed subject matter is not limited in this respect.

The WWAN transceiver 420 couples to one or more power amps 442 respectively coupled to one or more antennas 424 for sending and receiving radio-frequency signals via the WWAN broadband network. The baseband processor 412 also may control a wireless local area network (WLAN) transceiver 426 coupled to one or more suitable antennas 428 and which may be capable of communicating via a Wi-Fi, Bluetooth®, and/or an amplitude modulation (AM) or frequency modulation (FM) radio standard including an IEEE 802.11 a/b/g/n standard or the like. It should be noted that these are merely example implementations for applications processor 410 and baseband processor 412, and the scope of the claimed subject matter is not limited in these respects. For example, any one or more of SDRAM 414, NAND flash 416 and/or NOR flash 418 may comprise other types of memory technology such as magnetic memory, chalcogenide memory, phase change memory, or ovonic memory, and the scope of the claimed subject matter is not limited in this respect.

In one or more embodiments, applications processor 410 may drive a display 430 for displaying various information or data, and may further receive touch input from a user via a touch screen 432 for example via a finger or a stylus. An ambient light sensor 434 may be utilized to detect an amount of ambient light in which information handling system 400 is operating, for example to control a brightness or contrast value for display 430 as a function of the intensity of ambient light detected by ambient light sensor 434. One or more cameras 436 may be utilized to capture images that are processed by applications processor 410 and/or at least temporarily stored in NAND flash 416. Furthermore, applications processor may couple to a gyroscope 438, accelerometer 440, magnetometer 442, audio coder/decoder (CODEC) 444, and/or global positioning system (GPS) controller 446 coupled to an appropriate GPS antenna 448, for detection of various environmental properties including location, movement, and/or orientation of information handling system 400. Alternatively, controller 446 may comprise a Global Navigation Satellite System (GNSS) controller. Audio CODEC 444 may be coupled to one or more audio ports 450 to provide microphone input and speaker outputs either via internal devices and/or via external devices coupled to information handling system via the audio ports 450, for example via a headphone and microphone jack. In addition, applications processor 410 may couple to one or more input/output (I/O) transceivers 452 to couple to one or more I/O ports 454 such as a universal serial bus (USB) port, a high-definition multimedia interface (HDMI) port, a serial port, and so on. Furthermore, one or more of the I/O transceivers 452 may couple to one or more memory slots 456 for optional removable memory such as secure digital (SD) card or a subscriber identity module (SIM) card, although the scope of the claimed subject matter is not limited in these respects.

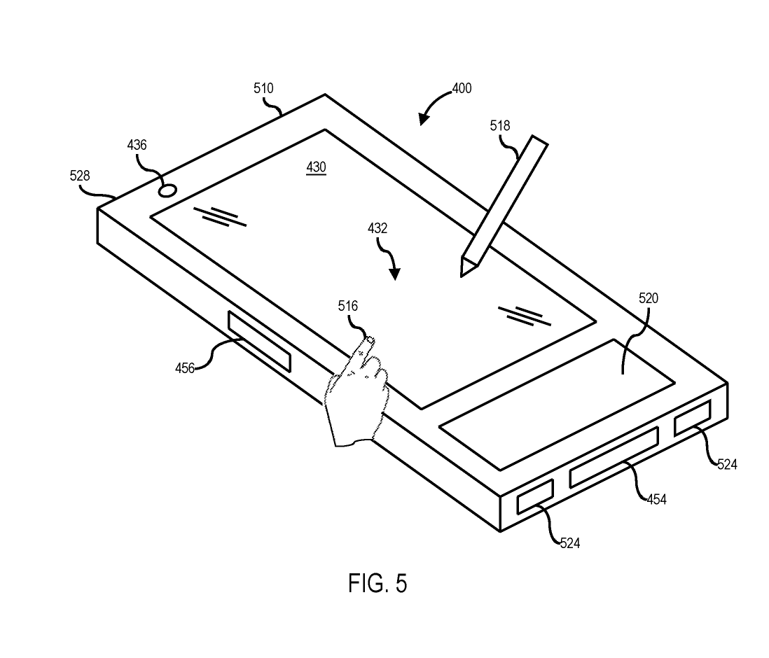

Referring now to FIG. 5, an isometric view of an information handling system of FIG. 4 that optionally may include a touch screen in accordance with one or more embodiments will be discussed. FIG. 5 shows an example implementation of information handling system 400 of FIG. 4 tangibly embodied as a cellular telephone, smartphone, or tablet type device or the like. The information handling system 400 may comprise a housing 510 having a display 430 which may include a touch screen 432 for receiving tactile input control and commands via a finger 516 of a user and/or a via stylus 518 to control one or more applications processors 410. The housing 510 may house one or more components of information handling system 400, for example one or more applications processors 410, one or more of SDRAM 414, NAND flash 416, NOR flash 418, baseband processor 412, and/or WWAN transceiver 420. The information handling system 400 further optionally may include a physical actuator area 520 which may comprise a keyboard or buttons for controlling information handling system via one or more buttons or switches. The information handling system 400 may also include a memory port or slot 456 for receiving non-volatile memory such as flash memory, for example in the form of a secure digital (SD) card or a subscriber identity module (SIM) card. Optionally, the information handling system 400 may further include one or more speakers and/or microphones 524 and a connection port 454 for connecting the information handling system 400 to another electronic device, dock, display, battery charger, and so on. In addition, information handling system 400 may include a headphone or speaker jack 528 and one or more cameras 436 on one or more sides of the housing 510. It should be noted that the information handling system 400 of FIG. 5 may include more or fewer elements than shown, in various arrangements, and the scope of the claimed subject matter is not limited in this respect.

As used herein, the terms “circuit” or “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

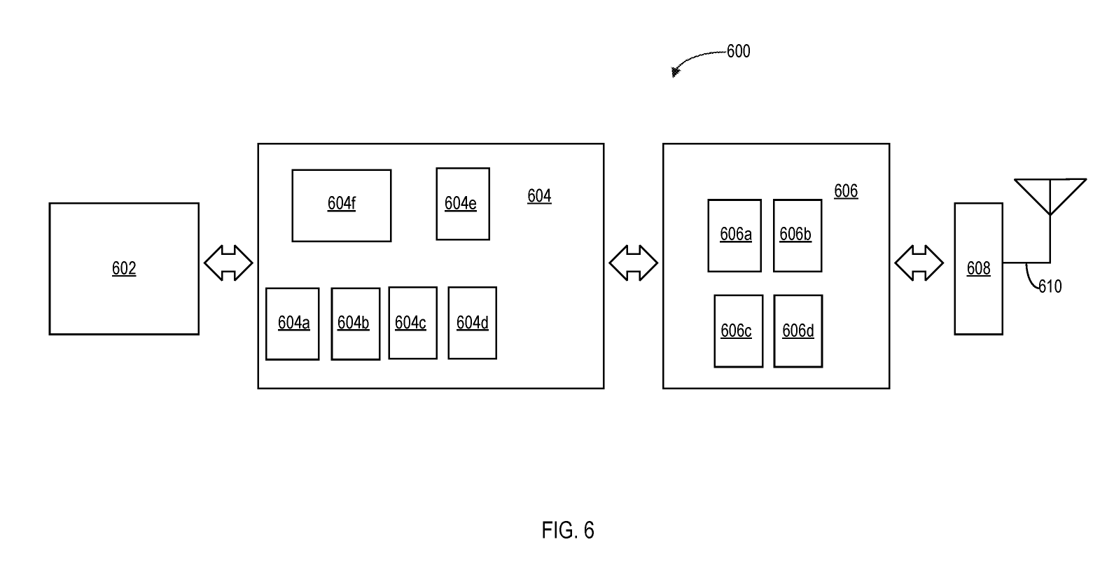

Referring now to FIG. 6, example components of a wireless device such User Equipment (UE) device 600 in accordance with one or more embodiments will be discussed. User equipment (UE) 600 may correspond, for example, UE 116 of FIG. 1 or FIG. 2, or alternatively to eNB 110 of FIG. 1 or FIG. 2, although the scope of the claimed subject matter is not limited in this respect. In some embodiments, UE device (or eNB device) 600 may include application circuitry 602, baseband circuitry 604, Radio Frequency (RF) circuitry 606, front-end module (FEM) circuitry 608 and one or more antennas 610, coupled together at least as shown and described herein.

Application circuitry 602 may include one or more applications processors. For example, application circuitry 602 may include circuitry such as, but not limited to, one or more single-core or multi-core processors. The one or more processors may include any combination of general-purpose processors and dedicated processors, for example graphics processors, application processors, and so on. The processors may be coupled with and/or may include memory and/or storage and may be configured to execute instructions stored in the memory and/or storage to enable various applications and/or operating systems to run on the system.

Baseband circuitry 604 may include circuitry such as, but not limited to, one or more single-core or multi-core processors. Baseband circuitry 604 may include one or more baseband processors and/or control logic to process baseband signals received from a receive signal path of RF circuitry 606 and to generate baseband signals for a transmit signal path of the RF circuitry 606. Baseband processing circuitry 604 may interface with the application circuitry 602 for generation and processing of the baseband signals and for controlling operations of the RF circuitry 606. For example, in some embodiments, the baseband circuitry 604 may include a second generation (2G) baseband processor 604a, third generation (3G) baseband processor 604b, fourth generation (4G) baseband processor 604c, and/or one or more other baseband processors 604d for other existing generations, generations in development or to be developed in the future, for example fifth generation (5G), sixth generation (6G), and so on. Baseband circuitry 604, for example one or more of baseband processors 604a through 604d, may handle various radio control functions that enable communication with one or more radio networks via RF circuitry 606. The radio control functions may include, but are not limited to, signal modulation and/or demodulation, encoding and/or decoding, radio frequency shifting, and so on. In some embodiments, modulation and/or demodulation circuitry of baseband circuitry 604 may include Fast-Fourier Transform (FFT), precoding, and/or constellation mapping and/or demapping functionality. In some embodiments, encoding and/or decoding circuitry of baseband circuitry 804 may include convolution, tail-biting convolution, turbo, Viterbi, and/or Low Density Parity Check (LDPC) encoder and/or decoder functionality. Embodiments of modulation and/or demodulation and encoder and/or decoder functionality are not limited to these examples and may include other suitable functionality in other embodiments.

In some embodiments, baseband circuitry 604 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. Processor 604e of the baseband circuitry 604 may be configured to run elements of the protocol stack for signaling of the PHY, MAC, RLC, PDCP and/or RRC layers. In some embodiments, the baseband circuitry may include one or more audio digital signal processors (DSP) 604f. The one or more audio DSPs 604f may include elements for compression and/or decompression and/or echo cancellation and may include other suitable processing elements in other embodiments. Components of the baseband circuitry may be suitably combined in a single chip, a single chipset, or disposed on a same circuit board in some embodiments. In some embodiments, some or all of the constituent components of baseband circuitry 604 and application circuitry 602 may be implemented together such as, for example, on a system on a chip (SOC).

In some embodiments, baseband circuitry 604 may provide for communication compatible with one or more radio technologies. For example, in some embodiments, baseband circuitry 604 may support communication with an evolved universal terrestrial radio access network (EUTRAN) and/or other wireless metropolitan area networks (WMAN), a wireless local area network (WLAN), a wireless personal area network (WPAN). Embodiments in which baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, RF circuitry 606 may include switches, filters, amplifiers, and so on, to facilitate the communication with the wireless network. RF circuitry 606 may include a receive signal path which may include circuitry to down-convert RF signals received from FEM circuitry 608 and provide baseband signals to baseband circuitry 604. RF circuitry 606 may also include a transmit signal path which may include circuitry to up-convert baseband signals provided by the baseband circuitry 1004 and provide RF output signals to FEM circuitry 1008 for transmission.

In some embodiments, RF circuitry 606 may include a receive signal path and a transmit signal path. The receive signal path of RF circuitry 606 may include mixer circuitry 606a, amplifier circuitry 606b and filter circuitry 606c. The transmit signal path of RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from FEM circuitry 608 based on the synthesized frequency provided by synthesizer circuitry 606d. Amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to baseband circuitry 604 for further processing. In some embodiments, the output baseband signals may be zero-frequency baseband signals, although this is not a requirement. In some embodiments, mixer circuitry 606a of the receive signal path may comprise passive mixers, although the scope of the embodiments is not limited in this respect.

In some embodiments, mixer circuitry 606a of the transmit signal path may be configured to up-convert input baseband signals based on the synthesized frequency provided by synthesizer circuitry 606d to generate RF output signals for FEM circuitry 608. The baseband signals may be provided by the baseband circuitry 604 and may be filtered by filter circuitry 606c. Filter circuitry 606c may include a low-pass filter (LPF), although the scope of the embodiments is not limited in this respect.

In some embodiments, mixer circuitry 606a of the receive signal path and the mixer circuitry 606a of the transmit signal path may include two or more mixers and may be arranged for quadrature down conversion and/or up conversion respectively. In some embodiments, mixer circuitry 606a of the receive signal path and the mixer circuitry 606a of the transmit signal path may include two or more mixers and may be arranged for image rejection, for example Hartley image rejection. In some embodiments, mixer circuitry 606a of the receive signal path and the mixer circuitry 606a may be arranged for direct down conversion and/or direct up conversion, respectively. In some embodiments, mixer circuitry 606a of the receive signal path and mixer circuitry 606a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, RF circuitry 1006 may include analog-to-digital converter (ADC) and digital-to-analog converter (DAC) circuitry, and baseband circuitry 604 may include a digital baseband interface to communicate with RF circuitry 606. In some dual-mode embodiments, separate radio integrated circuit (IC) circuitry may be provided for processing signals for one or more spectra, although the scope of the embodiments is not limited in this respect.

In some embodiments, synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

Synthesizer circuitry 606d may be configured to synthesize an output frequency for use by mixer circuitry 606a of RF circuitry 1006 based on a frequency input and a divider control input. In some embodiments, synthesizer circuitry 606d may be a fractional N/N+1 synthesizer.

In some embodiments, frequency input may be provided by a voltage controlled oscillator (VCO), although that is not a requirement. Divider control input may be provided by either baseband circuitry 604 or applications processor 602 depending on the desired output frequency. In some embodiments, a divider control input (e.g., N) may be determined from a look-up table based on a channel indicated by applications processor 602.

Synthesizer circuitry 606d of RF circuitry 1006 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1, for example based on a carry out, to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency, for example twice the carrier frequency, four times the carrier frequency, and so on, and used in conjunction with quadrature generator and divider circuitry to generate multiple signals at the carrier frequency with multiple different phases with respect to each other. In some embodiments, the output frequency may be a local oscillator (LO) frequency (fLO). In some embodiments, RF circuitry 1006 may include an in-phase and quadrature (IQ) and/or polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by RF circuitry 606 for transmission by one or more of the one or more antennas 610.

In some embodiments, FEM circuitry 608 may include a transmit/receive (TX/RX) switch to switch between transmit mode and receive mode operation. FEM circuitry 608 may include a receive signal path and a transmit signal path. The receive signal path of FEM circuitry 608 may include a low-noise amplifier (LNA) to amplify received RF signals and to provide the amplified received RF signals as an output, for example to RF circuitry 606. The transmit signal path of FEM circuitry 608 may include a power amplifier (PA) to amplify input RF signals, for example provided by RF circuitry 606, and one or more filters to generate RF signals for subsequent transmission, for example by one or more of antennas 610. In some embodiments, UE device 600 may include additional elements such as, for example, memory and/or storage, display, camera, sensor, and/or input/output (I/O) interface, although the scope of the claimed subject matter is not limited in this respect.

The following are example implementations of the subject matter described herein. It should be noted that any of the examples and the variations thereof described herein may be used in any permutation or combination of any other one or more examples or variations, although the scope of the claimed subject matter is not limited in these respects. In example one, an apparatus of a user equipment (UE) may comprise one or more baseband processors to decode one or more channel state information reference signals (CSI-RS) received from an evolved Node B (eNB) using open loop full-dimension multiple input, multiple output (FD-MIMO), and to generate feedback to the eNB responsive to the one or more CSI-RS signals, and a memory to store a Class A codebook from which the feedback is generated, wherein the feedback includes an i₁ codebook index of the Class A codebook and a channel quality indicator (CQI) determined based at least in part on i₂ codebook index cycling across one or more physical resource blocks (PRBs). In example two, the apparatus may include the subject matter of example one or any of the examples described herein, further comprising a radio-frequency (RF) transceiver to receive the one or more channel state information reference signals (CSI-RS) transmitted from the evolved Node B (eNB), and to transmit the feedback to the eNB as Class A feedback. In example three, the apparatus may include the subject matter of example one or any of the examples described herein, wherein the CQI is determined based at least in part using Codebook-Config=1. In example four, the apparatus may include the subject matter of example one or any of the examples described herein, wherein the CQI is determined based at least in part on i₂ index cycling among a subset of codebook indexes using an i₂ codebook index {0, 1} for rank two for the PRBs, wherein the CQI is determined based at least in part using Codebook-Config=1. In example five, the apparatus may include the subject matter of example one or any of the examples described herein, wherein the CQI is determined based at least in part on i₂ index cycling among a subset of codebook indexes using two codebook indexes {0, 1} for rank one for the PRBs, wherein resource elements (REs) of a physical downlink shared channel (PDSCH) in the PRBs are associated with the two codebook indexes, alternatively, wherein the CQI is determined based at least in part using Codebook-Config=1. In example six, the apparatus may include the subject matter of example one or any of the examples described herein, wherein the CQI is determined based at least in part on i₂ index cycling among a subset of one or more PRBs with different beams among all PRBs, wherein the CQI is determined based at least in part using Codebook-Config=2, Codebook-Config=3, or Codebook-Config=4, using codebook indexes {0, 4, 8, 12}, ad wherein each PRB is associated with one codebook index or two codebook indexes. In example seven, the apparatus may include the subject matter of example one or any of the examples described herein, wherein the CQI is determined based at least in part on i₂ index cycling among a subset of codebook indexes for rank two CQI for Codebook-Config=2, Codebook-Config=3, or Codebook-Config=4, and wherein the subset contains codewords with a same beam and different co-phasing for both layers. In example eight, the apparatus may include the subject matter of example one or any of the examples described herein, wherein the CQI is determined based at least in part on i₂ index cycling among a subset of codebook indexes for rank 3, rank 4, rank 5, rank 6, rank 7, or rank 8 CQI for Codebook-Config=2, Codebook-Config=3, or Codebook-Config=4, and wherein the subset contains a single codeword. In example nine, the apparatus may include the subject matter of example one or any of the examples described herein, wherein the feedback comprises an i_{1,1} codebook index, and wherein the CQI is determined based at least in part on i_{1,2} and i₂ cycling for each PRB when deriving CQI. In example ten, the apparatus may include the subject matter of example one or any of the examples described herein, wherein the feedback comprises an i_{1,2} codebook index, and wherein the CQI is determined based at least in part on i_{1,1} and i₂ cycling for each PRB when deriving CQI. In example eleven, the apparatus may include the subject matter of example one or any of the examples described herein, wherein the feedback comprises an i_{1,2} index, wherein the CQI is determined based at least in part on a subset codebook indexes, wherein i₂ is selected from one subset using codebook index 0 for rank 1, rank 2, rank 5, rank 6, rank 7, or rank 8, among all PRBs, wherein the CQI is determined based at least in part using Codebook-Config=1, and wherein for rank 1, each of the PRBs is associated with one i_{1,1} index or two i_{1,1} indexes wherein parameter D1 is described in a specification, equal to O1, or higher layer configured. In example twelve, the apparatus may include the subject matter of example one or any of the examples described herein, wherein the feedback comprises an i_{1,2} codebook index and wherein the CQI is determined based at least in part on i_{1,1} cycling among a subset of codebook indexes, wherein an i₂ codebook index is selected from one subset using codebook index 0 for rank 3 or rank 4 among the PRBs, and wherein the CQI is determined based at least in part using Codebook-Config=1. In example thirteen, the apparatus may include the subject matter of example one or any of the examples described herein, wherein the feedback comprises an i_{1,2} codebook index and wherein the CQI is determined based at least in part on i_{1,1} cycling among a subset of codebook indexes, and wherein an i₂ codebook index is selected from one subset of codebook indexes for rank 1 or rank 2 among the PRBs, wherein the CQI is determined based at least in part using Codebook-Config=2, Codebook-Config=3, or Codebook-Config=4, wherein S1(v) is a rank dependent bit width of N1 dimension, and wherein for rank 1 each of the PRBs is associated with one or two cycled precoders. In example fourteen, the apparatus may include the subject matter of example one or any of the examples described herein, wherein the feedback does not include an i₁ codebook index or an i₂ codebook index, wherein the CQI is determined based at least in part on i₁ codebook index cycling and i₂ codebook index cycling for each of the PRBs when deriving CQI.

In example fifteen, an apparatus of a user equipment (UE) may comprise one or more baseband processors to decode one or more channel state information reference signals (CSI-RS) received from an evolved Node B (eNB) using open loop full-dimension multiple input, multiple output (FD-MIMO), and to generate feedback to the eNB responsive to the one or more CSI-RS signals, and a memory to store a Class B codebook from which the feedback is generated, wherein an available codebook index for one or more ranks is cycled alternatively for each of one or more physical resource blocks wherein a physical resource block (PRB) is associated with either one precoder or two different precoders. In example sixteen, the apparatus may include the subject matter of example fifteen or any of the examples described herein, further comprising a radio-frequency (RF) transceiver to receive the one or more channel state information reference signals (CSI-RS) transmitted from the evolved Node B (eNB). and to transmit the feedback to the eNB as Class B feedback. In example seventeen, the apparatus may include the subject matter of example fifteen or any of the examples described herein, wherein the UE is configured with CSI-RS {15, 16} and one precoder in a two ports codebook for one or more PRBs. In example eighteen, the apparatus may include the subject matter of example fifteen or any of the examples described herein, wherein the UE configured with CSI-RS {15, 16, 17, 18}, and for rank one, two codebook indexes are utilized to cycle among PRBs according to Table 7.2.4-19 of Third Generation Partnership Project (3GPP) Technical Standard (TS) 36.213 v13.0.1, wherein a first codebook index is from {0, 1, 2, 3} and a second codebook index is from {4, 5, 6, 7}, wherein codebook index 0 and 4 are used on one or more of the PRBs alternatively, or two codebook indexes are used for one or more of the PRBs with each PRB associated with two precoders. In example nineteen, the apparatus may include the subject matter of example fifteen or any of the examples described herein, wherein the UE is configured with CSI-RS {15, 16, 17, 18}, and for rank two, two codebook indexes are used to cycle among PRBs according to Table 7.2.4-19 of Third Generation Partnership Project (3GPP) Technical Standard (TS) 36.213 v13.0.1, wherein a first codebook index is from {0, 1} and a second codebook index is from {2, 3}. In example twenty, the apparatus may include the subject matter of example fifteen or any of the examples described herein, wherein the UE is configured with CSI-RS {15, 16, 17, 18}, and for rank two, two codebook indexes are used to rotate among PRBs according to Table 7.2.4-19 of Third Generation Partnership Project (3GPP) Technical Standard (TS) 36.213 v13.0.1, wherein a first codebook index is from {4, 5} and a second codebook index is from {6, 7}. In example twenty-one, the apparatus may include the subject matter of example fifteen or any of the examples described herein, wherein the UE is configured with CSI-RS {15, 16, 17, 18}, and for rank two, one codebook index is used for one or more PRBs according to Table 7.2.4-19 of Third Generation Partnership Project (3GPP) Technical Standard (TS) 36.213 v13.0.1, wherein a codebook index is from {4, 5, 6, 7}. In example twenty-two, the apparatus may include the subject matter of example fifteen or any of the examples described herein, wherein the UE is configured with CSI-RS {15, 16, 17, 18}, and for rank three or rank four, one codebook index is used for one or more PRBs according to Table 7.2.4-19 of Third Generation Partnership Project (3GPP) Technical Standard (TS) 36.213 v13.0.1. In example twenty-three, the apparatus may include the subject matter of example fifteen or any of the examples described herein, wherein the UE is configured with CSI-RS {15, 16, 17, 18, 19, 20, 21, 22}, and for rank one, four codebook indexes are used to rotate among PRBs according to Table 7.2.4-19 of Third Generation Partnership Project (3GPP) Technical Standard (TS) 36.213 v13.0.1, wherein a kth codebook index is from {4k, 4k+1, 4k+2, 4k+3}. In example twenty-four, the apparatus may include the subject matter of example fifteen or any of the examples described herein, wherein the UE is configured with CSI-RS {15, 16, 17, 18, 19, 20, 21, 22}, and for rank two, four codebook indexes are used to cycle among PRBs according to Table 7.2.4-19 of Third Generation Partnership Project (3GPP) Technical Standard (TS) 36.213 v13.0.1, wherein a kth codebook index is from {2k, 2k+1}. In example twenty-five, the apparatus may include the subject matter of example fifteen or any of the examples described herein, wherein the UE is configured with CSI-RS {15, 16, 17, 18, 19, 20, 21, 22}, and for rank two, two codebook indexes are used to cycle among PRBs according to Table 7.2.4-19 of Third Generation Partnership Project (3GPP) Technical Standard (TS) 36.213 v13.0.1, wherein two codebook indexes are from codebook index {8, 9, 10, 11, 12, 13, 14, 15} and four beam directions are covered. In example twenty-six, the apparatus may include the subject matter of example fifteen or any of the examples described herein, wherein the UE is configured with CSI-RS {15, 16, 17, 18, 19, 20, 21, 22}, and for rank three, two codebook indexes are used to cycle among PRBs according to Table 7.2.4-19 of Third Generation Partnership Project (3GPP) Technical Standard (TS) 36.213 v13.0.1, and four beam directions are covered. In example twenty-seven, the apparatus may include the subject matter of example fifteen or any of the examples described herein, wherein the UE is configured with CSI-RS {15, 16, 17, 18, 19, 20, 21, 22}, and for rank four, two codebook indexes are used to cycle among PRBs according to Table 7.2.4-19 of Third Generation Partnership Project (3GPP) Technical Standard (TS) 36.213 v13.0.1, and four beam directions are covered. In example twenty-eight, the apparatus may include the subject matter of example fifteen or any of the examples described herein, wherein the UE is configured with CSI-RS {15, 16, 17, 18, 19, 20, 21, 22}, and for rank 5, rank 6, rank 7, or rank 8, one codebook index is used for one or more PRBs according to Table 7.2.4-19 of Third Generation Partnership Project (3GPP) Technical Standard (TS) 36.213 v13.0.1, and four beam directions are covered. In example twenty-nine, the apparatus may include the subject matter of example fifteen or any of the examples described herein, wherein the UE is configured for Class B operation with more than one CSI-RS resource configured, wherein a number of CSI-RS ports for each CSI-RS resource is 1 or 2, and CSI-RS resource indicator (CRI) cycling is used among one or more PRBs, a fixed precoding matrix indicator (PMI) index is used to derive a channel quality indicator (CQI) or rank indicator (RI), wherein for or rank 1, two PMI values are cycled per PRB for each cycled CRI. In example thirty, the apparatus may include the subject matter of example fifteen or any of the examples described herein, wherein a number of CSI-RS ports for each CSI-RS resource is 4, and CSI-RS resource indicator (CRI) cycling and precoding matrix indicator (PMI) cycling is used among one or more PRBs to derive a channel quality indicator (CQI) or rank indicator (RI), wherein CRI is to cycle every four PRBs, PMI is to cycle every PRB, and a precoder corresponding to precoder indexes 12, 13, 14, 15 in Table 6.3.4.2.3-2 of Third Generation Partnership Project (3GPP) Technical Standard (TS) 36.211 is used, and for rank 1, two CRI values are used per PRB for a same PMI, or two PMI values are used per PRB for a same CRI. In example thirty-one, the apparatus may include the subject matter of example fifteen or any of the examples described herein, wherein the UE is configured with a legacy 2/4Tx codebook with K=1 and configured with CSI-RS {15, 16}, and for rank one, four codebook indexes are used to cycle among PRBs with one precoder per PRB to derive a channel quality indicator (CQI), four codebook indexes are used to cycle among PRBs with two precoders per PRBs, and resource elements (REs) of one PRB are associated with either of two precoders. In example thirty-two, the apparatus may include the subject matter of example fifteen or any of the examples described herein, wherein the UE is configured with CSI-RS {15, 16, 17, 18}, and for rank one, a first group of eight codebook indexes are used for cycling among PRBs with one precoder per PRB to derive a channel quality indicator (CQI), or all codebook indexes are used for rotating among PRBs with two precoders per PRBs, and resource elements (REs) of one PRB are associated with either of two precoders. In example thirty-three, the apparatus may include the subject matter of example fifteen or any of the examples described herein, wherein different precoder subsets are applied to different CSI reporting subframes for open loop FD-MIMO transmission. In example thirty-four, the apparatus may include the subject matter of example fifteen or any of the examples described herein, wherein different precoder subsets to cycle are dependent on system bandwidth. In example thirty-five, the apparatus may include the subject matter of example fifteen or any of the examples described herein, wherein the precoders subset to cycle through PRBs are configured by high layer signaling for codebook subsets. In example thirty-six, the apparatus may include the subject matter of example fifteen or any of the examples described herein, wherein a random seed is used to select precoder subsets for different CSI reporting subframes, wherein the ransom seed is a function of TP or cell ID, or virtual cell ID and subframe index. In example thirty-seven, the apparatus may include the subject matter of example fifteen or any of the examples described herein, wherein the PRBs comprise one or more groups of PRBs.

In example thirty-eight, one or more computer-readable media may have instructions stored thereon that, if executed by a user equipment (UE), result in decoding one or more channel state information reference signals (CSI-RS) received from an evolved Node B (eNB) using open loop full-dimension multiple input, multiple output (FD-MIMO), generating feedback to the eNB responsive to the one or more CSI-RS signals, and storing a Class A codebook from which the feedback is generated, wherein the feedback includes an i1 codebook index of the Class A codebook and a channel quality indicator (CQI) determined based at least in part on i2 codebook index cycling across one or more physical resource blocks (PRBs). In example thirty-nine, the one or more computer-readable media may include the subject matter of example thirty-eight or any of the examples described herein, wherein the CQI is determined based at least in part using Codebook-Config=1. In example forty, the one or more computer-readable media may include the subject matter of example thirty-eight or any of the examples described herein, wherein the CQI is determined based at least in part on i2 index cycling among a subset of codebook indexes using an i2 codebook index {0, 1} for rank two for the PRBs, wherein the CQI is determined based at least in part using Codebook-Config=1. In example forty-one, the one or more computer-readable media may include the subject matter of example thirty-eight or any of the examples described herein, wherein the CQI is determined based at least in part on i2 index cycling among a subset of codebook indexes using two codebook indexes {0, 1} for rank one for the PRBs, wherein resource elements (REs) of a physical downlink shared channel (PDSCH) in the PRBs are associated with the two codebook indexes, alternatively, wherein the CQI is determined based at least in part using Codebook-Config=1. In example forty-two, the one or more computer-readable media may include the subject matter of example thirty-eight or any of the examples described herein, wherein the CQI is determined based at least in part on i2 index cycling among a subset of codebook indexes for rank two CQI for Codebook-Config=2, Codebook-Config=3, or Codebook-Config=4, and wherein the subset contains codewords with a same beam and different co-phasing for both layers. In example forty-three, one or more computer-readable media may have instructions stored thereon that, if executed by a user equipment (UE), result in decoding one or more channel state information reference signals (CSI-RS) received from an evolved Node B (eNB) using open loop full-dimension multiple input, multiple output (FD-MIMO), generating feedback to the eNB responsive to the one or more CSI-RS signals, and storing a Class B codebook from which the feedback is generated, wherein an available codebook index for one or more ranks is cycled alternatively for each of one or more physical resource blocks wherein a physical resource block (PRB) is associated with either one precoder or two different precoders. In example forty-four, the one or more computer-readable media may include the subject matter of example forty-three or any of the examples described herein, wherein the instructions configure the UE with CSI-RS {15, 16} and one precoder in a two ports codebook for one or more PRBs. In example forty-five, the one or more computer-readable media may include the subject matter of example forty-three or any of the examples described herein, wherein the instruction configure the UE with CSI-RS {15, 16, 17, 18}, and for rank one, two codebook indexes are utilized to cycle among PRBs according to Table 7.2.4-19 of Third Generation Partnership Project (3GPP) Technical Standard (TS) 36.213 v13.0.1, wherein a first codebook index is from {0, 1, 2, 3} and a second codebook index is from {4, 5, 6, 7}, wherein codebook index 0 and 4 are used on one or more of the PRBs alternatively, or two codebook indexes are used for one or more of the PRBs with each PRB associated with two precoders. In example forty-six, the one or more computer-readable media may include the subject matter of example forty-three or any of the examples described herein, wherein the instructions configure the UE with CSI-RS {15, 16, 17, 18}, and for rank two, two codebook indexes are used to cycle among PRBs according to Table 7.2.4-19 of Third Generation Partnership Project (3GPP) Technical Standard (TS) 36.213 v13.0.1, wherein a first codebook index is from {0, 1} and a second codebook index is from {2, 3}. In example forty-seven, the one or more computer-readable media may include the subject matter of example forty-three or any of the examples described herein, wherein the instructions configure the UE with CSI-RS {15, 16, 17, 18}, and for rank two, two codebook indexes are used to rotate among PRBs according to Table 7.2.4-19 of Third Generation Partnership Project (3GPP) Technical Standard (TS) 36.213 v13.0.1, wherein a first codebook index is from {4, 5} and a second codebook index is from {6, 7}.

In example forty-eight, an apparatus of a user equipment (UE) may comprise means for decoding one or more channel state information reference signals (CSI-RS) received from an evolved Node B (eNB) using open loop full-dimension multiple input, multiple output (FD-MIMO), means for generating feedback to the eNB responsive to the one or more CSI-RS signals, and means for storing a Class A codebook from which the feedback is generated, wherein the feedback includes an i1 codebook index of the Class A codebook and a channel quality indicator (CQI) determined based at least in part on i2 codebook index cycling across one or more physical resource blocks (PRBs). In example forty-nine, the apparatus may include the subject matter of example forty-eight or any of the examples described herein, wherein the CQI is determined based at least in part using Codebook-Config=1. In example fifty, the apparatus may include the subject matter of example forty-eight or any of the examples described herein, wherein the CQI is determined based at least in part on i2 index cycling among a subset of codebook indexes using an i2 codebook index {0, 1} for rank two for the PRBs, wherein the CQI is determined based at least in part using Codebook-Config=1. In example fifty-one, the apparatus may include the subject matter of example forty-eight or any of the examples described herein, wherein the CQI is determined based at least in part on i2 index cycling among a subset of codebook indexes using two codebook indexes {0, 1} for rank one for the PRBs, wherein resource elements (REs) of a physical downlink shared channel (PDSCH) in the PRBs are associated with the two codebook indexes, alternatively, wherein the CQI is determined based at least in part using Codebook-Config=1. In example fifty-two, the apparatus may include the subject matter of example forty-eight or any of the examples described herein, wherein the CQI is determined based at least in part on i2 index cycling among a subset of codebook indexes for rank two CQI for Codebook-Config=2, Codebook-Config=3, or Codebook-Config=4, and wherein the subset contains codewords with a same beam and different co-phasing for both layers.

In example fifty-three, an apparatus of a user equipment (UE) may comprise means for decoding one or more channel state information reference signals (CSI-RS) received from an evolved Node B (eNB) using open loop full-dimension multiple input, multiple output (FD-MIMO). means for generating feedback to the eNB responsive to the one or more CSI-RS signals, and means for storing a Class B codebook from which the feedback is generated, wherein an available codebook index for one or more ranks is cycled alternatively for each of one or more physical resource blocks wherein a physical resource block (PRB) is associated with either one precoder or two different precoders. In example fifty-four, the apparatus may include the subject matter of example fifty-three or any of the examples described herein, and further may comprise means for configuring the UE with CSI-RS {15, 16} and one precoder in a two ports codebook for one or more PRBs. In example fifty-five, the apparatus may include the subject matter of example fifty-three or any of the examples described herein, and further may comprise means for configuring the UE with CSI-RS {15, 16, 17, 18}, and for rank one, two codebook indexes are utilized to cycle among PRBs according to Table 7.2.4-19 of Third Generation Partnership Project (3GPP) Technical Standard (TS) 36.213 v13.0.1, wherein a first codebook index is from {0, 1, 2, 3} and a second codebook index is from {4, 5, 6, 7}, wherein codebook index 0 and 4 are used on one or more of the PRBs alternatively, or two codebook indexes are used for one or more of the PRBs with each PRB associated with two precoders. In example fifty-six, the apparatus may include the subject matter of example fifty-three or any of the examples described herein, and further may comprise means for configuring the UE with CSI-RS {15, 16, 17, 18}, and for rank two, two codebook indexes are used to cycle among PRBs according to Table 7.2.4-19 of Third Generation Partnership Project (3GPP) Technical Standard (TS) 36.213 v13.0.1, wherein a first codebook index is from {0, 1} and a second codebook index is from {2, 3}. In example fifty-seven, the apparatus may include the subject matter of example fifty-three or any of the examples described herein, and further may comprise means for configuring the UE with CSI-RS {15, 16, 17, 18}, and for rank two, two codebook indexes are used to rotate among PRBs according to Table 7.2.4-19 of Third Generation Partnership Project (3GPP) Technical Standard (TS) 36.213 v13.0.1, wherein a first codebook index is from {4, 5} and a second codebook index is from {6, 7}. In example fifty-eight, machine-readable storage may include machine-readable instructions, when executed, to realize an apparatus as claimed in any preceding example.

Although the claimed subject matter has been described with a certain degree of particularity, it should be recognized that elements thereof may be altered by persons skilled in the art without departing from the spirit and/or scope of claimed subject matter. It is believed that the subject matter pertaining to CSI feedback for open loop FD-MIMO transmission and many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

1-25. (canceled)

26. An apparatus of a user equipment (UE), comprising:
one or more baseband processors to decode one or more channel state information reference signals (CSI-RS) received from an evolved Node B (eNB) using open loop full-dimension multiple input, multiple output (FD-MIMO), and to generate feedback to the eNB responsive to the one or more CSI-RS signals; and
a memory to store a Class A codebook from which the feedback is generated, wherein the feedback includes an i₁ codebook index of the Class A codebook and a channel quality indicator (CQI) determined based at least in part on i₂ codebook index cycling across one or more physical resource blocks (PRBs).

27. The apparatus of claim 26, further comprising a radio-frequency (RF) transceiver to receive the one or more channel state information reference signals (CSI-RS) transmitted from the evolved Node B (eNB), and to transmit the feedback to the eNB as Class A feedback.

28. The apparatus of claim 26, wherein the CQI is determined based at least in part using Codebook-Config=1.

29. The apparatus of claim 26, wherein the CQI is determined based at least in part on i₂ index cycling among a subset of codebook indexes using an i₂ codebook index {0, 1} for rank two for the PRBs, wherein the CQI is determined based at least in part using Codebook-Config=1.

30. The apparatus of claim 26, wherein the CQI is determined based at least in part on i₂ index cycling among a subset of codebook indexes using two codebook indexes {0, 1} for rank one for the PRBs, wherein resource elements (REs) of a physical downlink shared channel (PDSCH) in the PRBs are associated with the two codebook indexes, alternatively, wherein the CQI is determined based at least in part using Codebook-Config=1.

31. The apparatus of claim 26, wherein the CQI is determined based at least in part on i₂ index cycling among a subset of one or more PRBs with different beams among all PRBs, wherein the CQI is determined based at least in part using Codebook-Config=2, Codebook-Config=3, or Codebook-Config=4, using codebook indexes {0, 4, 8, 12}, ad wherein each PRB is associated with one codebook index or two codebook indexes.

32. The apparatus of claim 26, wherein the CQI is determined based at least in part on i₂ index cycling among a subset of codebook indexes for rank two CQI for Codebook-Config=2, Codebook-Config=3, or Codebook-Config=4, and wherein the subset contains codewords with a same beam and different co-phasing for both layers.

33. An apparatus of a user equipment (UE), comprising:
one or more baseband processors to decode one or more channel state information reference signals (CSI-RS) received from an evolved Node B (eNB) using open loop full-dimension multiple input, multiple output (FD-MIMO), and to generate feedback to the eNB responsive to the one or more CSI-RS signals; and
a memory to store a Class B codebook from which the feedback is generated, wherein an available codebook index for one or more ranks is cycled alternatively for each of one or more physical resource blocks wherein a physical resource block (PRB) is associated with either one precoder or two different precoders.

34. The apparatus of claim 33, further comprising a radio-frequency (RF) transceiver to receive the one or more channel state information reference signals (CSI-RS) transmitted from the evolved Node B (eNB). and to transmit the feedback to the eNB as Class B feedback.

35. The apparatus of claim 33, wherein the UE is configured with CSI-RS {15, 16} and one precoder in a two ports codebook for one or more PRBs.

36. The apparatus of claim 33, wherein the UE configured with CSI-RS {15, 16, 17, 18}, and for rank one, two codebook indexes are utilized to cycle among PRBs according to Table 7.2.4-19 of Third Generation Partnership Project (3GPP) Technical Standard (TS) 36.213 v13.0.1, wherein a first codebook index is from {0, 1, 2, 3} and a second codebook index is from {4, 5, 6, 7}, wherein codebook index 0 and 4 are used on one or more of the PRBs alternatively, or two codebook indexes are used for one or more of the PRBs with each PRB associated with two precoders.

37. The apparatus of claim 33, wherein the UE is configured with CSI-RS {15, 16, 17, 18}, and for rank two, two codebook indexes are used to cycle among PRBs according to Table 7.2.4-19 of Third Generation Partnership Project (3GPP) Technical Standard (TS) 36.213 v13.0.1, wherein a first codebook index is from {0, 1} and a second codebook index is from {2, 3}.

38. The apparatus of claim 33, wherein the UE is configured with CSI-RS {15, 16, 17, 18}, and for rank two, two codebook indexes are used to rotate among PRBs according to Table 7.2.4-19 of Third Generation Partnership Project (3GPP) Technical Standard (TS) 36.213 v13.0.1, wherein a first codebook index is from {4, 5} and a second codebook index is from {6, 7}.

39. The apparatus of claim 33, wherein the UE is configured with CSI-RS {15, 16, 17, 18}, and for rank two, one codebook index is used for one or more PRBs according to Table 7.2.4-19 of Third Generation Partnership Project (3GPP) Technical Standard (TS) 36.213 v13.0.1, wherein a codebook index is from {4, 5, 6, 7}.

40. The apparatus of claim 33, wherein the UE is configured with CSI-RS {15, 16, 17, 18}, and for rank three or rank four, one codebook index is used for one or more PRBs according to Table 7.2.4-19 of Third Generation Partnership Project (3GPP) Technical Standard (TS) 36.213 v13.0.1.

41. One or more non-transitory computer-readable media having instructions stored thereon that, if executed by a user equipment (UE), result in:
decoding one or more channel state information reference signals (CSI-RS) received from an evolved Node B (eNB) using open loop full-dimension multiple input, multiple output (FD-MIMO);
generating feedback to the eNB responsive to the one or more CSI-RS signals; and
storing a Class A codebook from which the feedback is generated, wherein the feedback includes an i1 codebook index of the Class A codebook and a channel quality indicator (CQI) determined based at least in part on i2 codebook index cycling across one or more physical resource blocks (PRBs).

42. The one or more non-transitory computer-readable media of claim 41, wherein the CQI is determined based at least in part using Codebook-Config=1.

43. The one or more non-transitory computer-readable media of claim 41, wherein the CQI is determined based at least in part on i2 index cycling among a subset of codebook indexes using an i2 codebook index {0, 1} for rank two for the PRBs, wherein the CQI is determined based at least in part using Codebook-Config=1.

44. The one or more non-transitory computer-readable media of claim 41, wherein the CQI is determined based at least in part on i2 index cycling among a subset of codebook indexes using two codebook indexes {0, 1} for rank one for the PRBs, wherein resource elements (REs) of a physical downlink shared channel (PDSCH) in the PRBs are associated with the two codebook indexes, alternatively, wherein the CQI is determined based at least in part using Codebook-Config=1.

45. The one or more non-transitory computer-readable media of claim 41, wherein the CQI is determined based at least in part on i2 index cycling among a subset of codebook indexes for rank two CQI for Codebook-Config=2, Codebook-Config=3, or Codebook-Config=4, and wherein the subset contains codewords with a same beam and different co-phasing for both layers.

46. One or more non-transitory computer-readable media having instructions stored thereon that, if executed by a user equipment (UE), result in:
decoding one or more channel state information reference signals (CSI-RS) received from an evolved Node B (eNB) using open loop full-dimension multiple input, multiple output (FD-MIMO);
generating feedback to the eNB responsive to the one or more CSI-RS signals; and
storing a Class B codebook from which the feedback is generated, wherein an available codebook index for one or more ranks is cycled alternatively for each of one or more physical resource blocks wherein a physical resource block (PRB) is associated with either one precoder or two different precoders.

47. The one or more non-transitory computer-readable media of claim 46, wherein the instructions configure the UE with CSI-RS {15, 16} and one precoder in a two ports codebook for one or more PRBs.

48. The one or more non-transitory computer-readable media of claim 46, wherein the instruction configure the UE with CSI-RS {15, 16, 17, 18}, and for rank one, two codebook indexes are utilized to cycle among PRBs according to Table 7.2.4-19 of Third Generation Partnership Project (3GPP) Technical Standard (TS) 36.213 v13.0.1, wherein a first codebook index is from {0, 1, 2, 3} and a second codebook index is from {4, 5, 6, 7}, wherein codebook index 0 and 4 are used on one or more of the PRBs alternatively, or two codebook indexes are used for one or more of the PRBs with each PRB associated with two precoders.

49. The one or more non-transitory computer-readable media of claim 46, wherein the instructions configure the UE with CSI-RS {15, 16, 17, 18}, and for rank two, two codebook indexes are used to cycle among PRBs according to Table 7.2.4-19 of Third Generation Partnership Project (3GPP) Technical Standard (TS) 36.213 v13.0.1, wherein a first codebook index is from {0, 1} and a second codebook index is from {2, 3}.

50. The one or more non-transitory computer-readable media of claim 46, wherein the instructions configure the UE with CSI-RS {15, 16, 17, 18}, and for rank two, two codebook indexes are used to rotate among PRBs according to Table 7.2.4-19 of Third Generation Partnership Project (3GPP) Technical Standard (TS) 36.213 v13.0.1, wherein a first codebook index is from {4, 5} and a second codebook index is from {6, 7}.
